(19) United States
(12) Patent Application Publication
(10) Pub. No.: US 2025/0060056 A1
(43) Pub. Date: Feb. 20, 2025

(54) HOSE ASSEMBLY HAVING A STRUCTURE, DEVICE AND METHOD FOR INTRODUCING A STRUCTURE ON A HOSE ASSEMBLY, USE OF EMBOSSING ROLLERS

(71) Applicant: Neoperl GmbH, Müllheim (DE)

(72) Inventor: Martin Moritz, Landser (FR)

(73) Assignee: Neoperl GmbH, Müllheim (DE)

(21) Appl. No.: 18/797,793

(22) Filed: Aug. 8, 2024

(30) Foreign Application Priority Data
Aug. 14, 2023 (DE) 102023121715.1

(51) Int. Cl. F16L 11/11; B29C 59/02; B29C 59/04; B29K 21/00; B29L 23/00; B32B 1/08; B32B 3/30; B32B 7/02; B32B 27/08

(52) U.S. Cl. CPC F16L 11/11; B29C 59/021; B29C 59/043; B32B 1/08; B32B 3/30; B32B 7/02; B32B 27/08; B29K 2021/003; B29K 2995/0046; B29K 2995/0097; B29L 2023/005; B32B 2250/02; B32B 2250/24; B32B 2307/54; B32B 2597/00

(57) ABSTRACT

A hose assembly (1) is provided having a structure (2), in which the structure (2) has circumferential ribs (3), the axial extent of which varies, preferably periodically, along a circumference, and locally limited gap-filling elevations (4), as a result of which, a braiding impression is produced, without a separate braiding of the hose assembly (1) being carried out. The structure (2) is applied by at least two embossing dies (7), in particular embossing rollers (8), which are rollable on the hose assembly (1), in particular are rollable in synchronism on the hose assembly, and are part of an extrusion process.

### CROSS-REFERENCE TO RELATED APPLICATIONS

This application claims priority to German Patent Application No. 10 2023 121 715.1, filed Aug. 14, 2023, which is incorporated herein by reference as if fully set forth.

### TECHNICAL FIELD

The invention relates to a hose assembly, in particular for conducting fluids, having an external structure.

The invention further relates to a hose assembly, in particular for conducting fluids, having an external structure with at least one circumferential rib.

The invention further relates to a device for introducing a structure on a hose assembly, in particular for conducting fluids.

The invention also relates to a method for introducing a structure on an extruded hose assembly, in particular for conducting fluids.

The invention finally relates to the use of embossing rollers as part of an extrusion process for introducing a structure on a hose assembly, in particular fluid line.

### BACKGROUND

Hose assemblies having structures are known in practice, for example as braidings to improve the haptics or optical aspects.

### SUMMARY

The invention is based on the object of advantageously designing the optical and/or haptic and/or mechanical use properties of a hose assembly, preferably for use in the sanitary and heating sector. For this purpose, a multi-dimensional, preferably three-dimensional structure is embossed on an outer layer of a multi-layer extruded hose assembly, in particular for conducting fluids, by means of embossing dies, in particular embossing rollers, preferably above a glass transition temperature and/or as part of an extrusion process.

In order to achieve this object, the invention proposes one or more of the features disclosed herein. In particular, it is thus proposed according to the invention in a hose assembly, in particular for conducting fluids, having an external structure, that the structure, preferably composed of a thermoplastic, is embossed. The introduction of an embossing opens up a multiplicity of different design options through to simulations of braiding patterns.

It is advantageous if the embossing is carried out thermoplastically.

Therefore, designs having a particularly plastic effect are easily accessible.

Particularly advantageously, the embossed external structure can be used to improve, for example, haptic and/or optical properties of the hose assembly.

In a further advantageous embodiment, it may be provided that the structure is periodic in a running direction of the hose assembly.

Particularly advantageously, by means of a periodic external structure, for example, a periodically varying structure, of the hose assembly, it is possible, for example, to produce a braiding impression, without an actual braid having to be applied to the hose assembly.

Alternatively or additionally, it may be provided that the structure has different layer thicknesses, in particular an outer layer.

The outer layer of the hose assembly can define, for example, an outermost circumference of the hose assembly and/or can be the layer which is not in any fluid contact.

Particularly advantageously, by means of different layer thicknesses, for example, shape and/or pressure resistance and/or haptic properties of the hose assembly can be optimized and/or correspondingly adapted to the application.

In a further advantageous embodiment, it may be provided that the structure is formed in an outer layer applied to a preferably unembossed inner layer, which layers are connected to each other preferably in an integrally bonded manner.

Extremely advantageously, for example, an influence of the structure on a fluid flow, which is provided within the hose assembly during use and thus makes contact with the unembossed inner layer, can therefore be prevented. Thus, for example, it is possible to implement a wide range of structures without any problem and independently of flow properties of the fluid or a fluid within the hose assembly.

Furthermore, it can be provided, for example, that the mechanical properties are advantageously influenced in respect of buckling stiffness and bursting pressure by the outer layer, which is connected to the unembossed inner layer for example in an integrally bonded manner.

In a further advantageous embodiment, it may be provided that the or an outer layer of the hose assembly is composed of a thermoplastic.

For example, a buckling stiffness and/or a pressure resistance of the hose assembly can thus be increased extremely advantageously.

Alternatively or additionally, it can be advantageously provided that an outer layer of the hose assembly, for example, the already mentioned outer layer, is composed of an elastomer plastic.

Thus, for example, specific properties of the hose assembly can be achieved. Thus, for example, a non-slip surface of the outer hose can be advantageously achieved. Furthermore, for example, other advantageous haptic and/or optical effects can also be achieved by the elastomer outer hose.

In a further advantageous embodiment, it may be provided that a ratio of an outer hose wall thickness to an inner hose wall thickness of the hose assembly is greater than 0.1 and less than 5, in particular 0.1, 0.3 . . . 5, preferably 0.3. Particularly advantageously, for example, improved stability of the hose assembly can thus be achieved.

In a further advantageous embodiment, it may be provided that the embossed thermoplastic has a modulus of elasticity (e modulus) of at least 1000 MPa, in particular 1200 MPa, 1300 MPa, preferably 1700 MPa. The high strength of the outer hose thereby advantageously achieved thus increases its supporting effect on the inner hose.

As an alternative or in addition, in order to achieve the stated object, the features of the further independent claim, which is directed to a hose assembly, in particular for conducting fluids, with at least one circumferential rib, are provided according to the invention. In particular, it is thus proposed according to the invention that the at least one circumferential rib has an axial extent, which varies, preferably periodically, along a circumference, in particular wherein at least two preferably adjacent ribs are identical.

It is particularly advantageous that a braiding impression is produced with the circumferential ribs and the axial extent varying along a circumference without a separate braid being applied to the hose assembly. This advantageously results in the optical and/or haptic impression of a braid. It is also advantageous that without optical, haptic and/or qualitative impairments, material can thus be saved, process times can be significantly reduced and the entire manufacturing process can be simplified.

Alternatively or in addition, it is proposed according to the invention that gaps formed by a reduction in the axial extent are filled by locally limited, preferably matching, elevations.

It is particularly advantageous that, for example, a further improvement in the haptics and/or the braiding impression can thus be produced.

In a further advantageous embodiment, it may be provided that the hose assembly is formed in multiple layers, in particular two layers. It may be provided in this case, for example, that the structure is formed on an outer layer, and/or that there is an integrally bonded connection between at least two layers.

It may be provided, for example, that an inner layer contacts a, for example, flowing fluid and thus can and/or is intended to be designed to withstand corresponding flow properties and/or mechanical loads. The outer layer of the hose assembly can fulfill optical and/or haptic functions, for example, owing to the structure embossed thereon. Thus, for example, it may be provided that the inner layer is formed with a material that is differentiated from or identical to the outer layer.

example.

It is particularly advantageous that a nonreleasable connection between the two layers can thus be generated, wherein, also advantageously, each layer can be designed to be stiffer and/or more elastic in accordance with the loads or requirements.

In a further solution of the object set of possible independent inventive quality or in an advantageous embodiment of the solution described above and/or one of the embodiments described above, it may be provided that crossing and/or intersecting, in particular linear, depressions are formed at at least one point between two adjacent ribs.

The integrally bonded connection may be an adhesion connection, for

It is particularly advantageous that a visually clear transition between two adjacent ribs is thus generated and, as a result, in turn the braiding impression can be improved.

In a further advantageous embodiment, it may be provided that the ribs and/or the elevations are biconvex.

It is particularly advantageous that this results, for example, in special optics, which can be distinguished from a separately applied braid. Furthermore, it is advantageous that, in contrast with a rectilinear shape, a biconvex shape affords a higher contact surface, which in turn can generate an improvement in the haptics.

In a further advantageous embodiment, it may be provided that the elevations filling the gaps differ, in particular in their size, from the ribs.

For example, it may be provided that the elevations filling the gaps are smaller than the ribs.

It is particularly advantageous that, for example, the ribs and/or the elevations can thus be configured differently, as a result of which advantageously, in turn, different structures can be formed.

As an alternative or in addition, in order to achieve the stated object, the features of the further independent claim, which is directed to a hose assembly, in particular for conducting fluids, are provided according to the invention. In particular, it is thus proposed according to the invention that the structure has circumferential ribs, the axial extent of which varies, preferably periodically, along a circumference, wherein gaps formed by a reduction in the axial extent are filled by locally limited, preferably matching, elevations which are offset in axial extent with respect to the ribs, wherein preferably circumferential and/or closed, in particular linear, depressions are formed in a transition between a rib and an elevation, wherein at least two depressions preferably repeatedly cross one another.

It is particularly advantageous that by means of an axial offset of the elevations with respect to the ribs and the crossing, intersecting depressions in the transition between a rib and an elevation, for example, a braiding impression and/or the haptics of the structure can be improved.

As an alternative or in addition, in order to achieve the stated object, the features of the further independent claim, which is directed to a device for introducing a structure on a hose assembly, in particular for conducting fluids, are provided according to the invention. In particular, it is thus proposed according to the invention that the device is formed in a stationary and/or adaptable manner, in particular downstream of an extruder, with at least two embossing dies, in particular embossing rollers, which are rollable on the hose assembly, in particular are rollable synchronously to one another.

It can be provided, for example, that the device is positioned, for example, as a fixedly installable or adaptable add-on unit downstream of the extruder such that the structure can be embossed, for example, onto an outer layer, which is still plasticizable, of an extruded hose assembly, for example subsequently and/or as part of an extrusion process.

It is particularly advantageous, in the case of embossing rollers, that burr-free and/or uninterrupted endless hose assemblies can be produced, for example, in the manufacturing direction. Thus, likewise particularly advantageously, the circumferential burrs which are known in the case of corrugated hoses and disturb the optical impression and a braided appearance of the surface of the hose assembly, can be prevented.

Synchronization of the embossing rollers can be realized, for example, via an electronic control system.

It is particularly advantageous here that, for example, crossing and/or intersecting, in particular linear, depressions in the structure are thus aligned with one another, even if they are manufactured in the circumferential direction by different embossing rollers.

In a further advantageous embodiment, it may be provided that the at least two embossing dies, in particular embossing rollers, are formed opposite one another, in particular such that they form an abutment during the introduction of a structure on an extruded hose assembly.

Advantageously by this means, for example, a required stability for applying the structure and/or a defined contact pressure between the two embossing dies during the application of the structure can be generated.

In a further advantageous embodiment, it may be provided that the at least two embossing dies, in particular embossing rollers, are driven by a drive unit.

It is particularly advantageous that, for example, (pre) defined rotational speeds of the embossing dies which are rollable on the hose assembly can thus be generated.

In a further advantageous embodiment, it may be provided that the at least two embossing dies, in particular embossing rollers, are rotatably mounted by a respective positionable and/or adjustable holding device.

Via the positioning and/or infeed of the holding device, which can be designed, for example, as a jaw chuck, preferably as a four-jaw chuck, the embossing depth can thus be advantageously adjusted, in particular via an infeed. Furthermore, for example, the positioning of the holding device likewise makes it advantageously possible to allow sections of the hose assembly with embossing and without embossing to follow one another.

In this case, it is thus particularly advantageous, for example, for the embossing of the structure to be interrupted at the ends of the hose assembly by adjusting the embossing rollers so that, for example, a hose nipple can be molded on.

In a further advantageous embodiment, it may be provided that at least two opposite embossing dies are formed on an identical plane and/or axially offset, in particular at an angle, to one another with respect to at least two other opposite embossing dies.

It may be provided, for example, that the embossing dies are formed in pairs, for example, at right angles to each other.

It is advantageous if the at least two embossing dies together cover a complete circumference of the hose assembly. Unsightly longitudinal structures can thus be avoided or reduced.

It is particularly advantageous that, for example, the embossing dies, which are formed with a negative shape of the structure, can thus be produced more cost-effectively, since, for example, the complexity for manufacturing a single embossing die for embossing the entire structure can be simplified. Thus, it can be provided, for example, that the embossing dies, which are preferably formed in pairs, each introduce a pattern, with, for example, the totality of all of the patterns forming the structure.

It is also advantageous, for example in the case of embossing dies which are axially offset in pairs to one another and roll synchronously with respect to one another on the hose assembly, that, for example, an overlap of the embossing dies at the hose assembly can thus be made possible and the formation of axial ribs can be prevented.

As an alternative or in addition, in order to achieve the stated object, the features of the further independent claim, which is directed to a method for introducing a structure on an extruded hose assembly, in particular for conducting fluids, are provided according to the invention. In particular, it is thus proposed according to the invention that a second layer is applied to a first extruded layer in an integrally bonded manner, wherein a circumferential structure is applied to the second layer of the hose assembly, in particular the outer layer of the hose assembly, for example above a glass transition temperature, via at least two embossing dies, in particular embossing rollers, which are rollable on the hose assembly.

The second layer may be, for example, a cover layer, wherein the temperature above the glass transition temperature may be, for example, more than 200° C. It may be provided, for example, that the second layer is produced in an extrusion device preferably at 240° C., wherein, for example, at an outlet of the extrusion device, the second layer of the extruded hose assembly cools to, for example, 200° C. Thus, a pasty state of the cover layer, in which a very good embossing capability can be generated, is particularly advantageously achieved.

In a further advantageous embodiment, it may be provided that the at least two embossing dies, in particular embossing rollers, roll synchronously with respect to one another on the hose assembly.

It may also be provided, for example, that the synchronized embossing dies can be synchronized, for example, in addition to an advancing speed of the extruded hose assembly.

It is particularly advantageous that, for example, a continuous structure without axial ribs can thus be applied. This can be realized in particular if the embossing dies, which roll synchronously with respect to one another, are arranged, for example, offset from one another.

In a further advantageous embodiment, it may be provided that the embossing dies, in particular embossing rollers, are automatically and/or manually moved together and then moved apart in order to introduce the structure.

It is particularly advantageous that a defined embossing depth, for example, can thus be generated by an infeed with a defined infeed force and/or holding force, for example. Thus, for example, an embossing pattern of 3/10 mm can be achieved.

In a further advantageous embodiment, it may be provided that the embossing dies, in particular embossing rollers, are cooled before and/or during the introduction of the structure.

It may be provided, for example, that cooling of the embossing dies before and/or during the introduction of the structure is particularly advantageously selected such that, for example, adhesion of the tempered layer to an embossing die can be prevented and/or excluded.

As an alternative or in addition, in order to achieve the stated object, the features of the further independent claim, which is directed to the use of embossing dies, in particular embossing rollers, as part of an extrusion process for introducing a structure on a hose assembly, in particular for conducting fluids, are provided according to the invention. In particular, it is thus proposed according to the invention that at least two opposite embossing dies are rollable synchronously to one another on the hose assembly and/or form an abutment.

It may be provided, for example, that the embossing dies, in particular the embossing rollers, are positionable in a stationary and/or adaptable manner, directly downstream of an extruder or at the end of an extrusion device. It is particularly advantageous that, for example, the temperature control of the hose assembly can thus be used by the extrusion process to introduce the structure.

It is also advantageous if the extrusion process can be adjusted such that the temperature of the hose assembly at the end of an extrusion device lies, for example, above a glass transition temperature, since thus a good embossing capability of the hose assembly can be generated.

The effect which can also be advantageously achieved by synchronizing the embossing dies, which are rollable on the hose assembly, by means of an electronic control system is that, for example, depressions of the structure are aligned with one another, even if these depressions are manufactured, for example, in the circumferential direction by different embossing dies.

### BRIEF DESCRIPTION OF THE DRAWINGS

The invention will now be described in more detail on the basis of exemplary embodiments, but is not restricted to the exemplary embodiments. Further exemplary embodiments arise from combining the features of individual or multiple claims with one another and/or with individual or multiple features of the exemplary embodiment.

In the figures, in each case in a greatly simplified illustration:

FIG. 1 shows different three-dimensional views of a hose assembly having a structure,

FIG. 2 shows a three-dimensional view of an embossing die,

FIG. 3 shows a three-dimensional illustration of an embossing die which is mounted rotatably in a holding device,

FIG. 4 shows a three-dimensional illustration of an embossing die with an additional illustration of embossing dies, which are rollable in order to apply the structure on the hose assembly and lie opposite one another, during the introduction of the structure,

FIG. 5 shows a further three-dimensional illustration with in each case two embossing dies, which lie opposite each other and are rollable on the hose assembly, in in each case rotatably mounted holding devices during the introduction of the structure.

### DETAILED DESCRIPTION

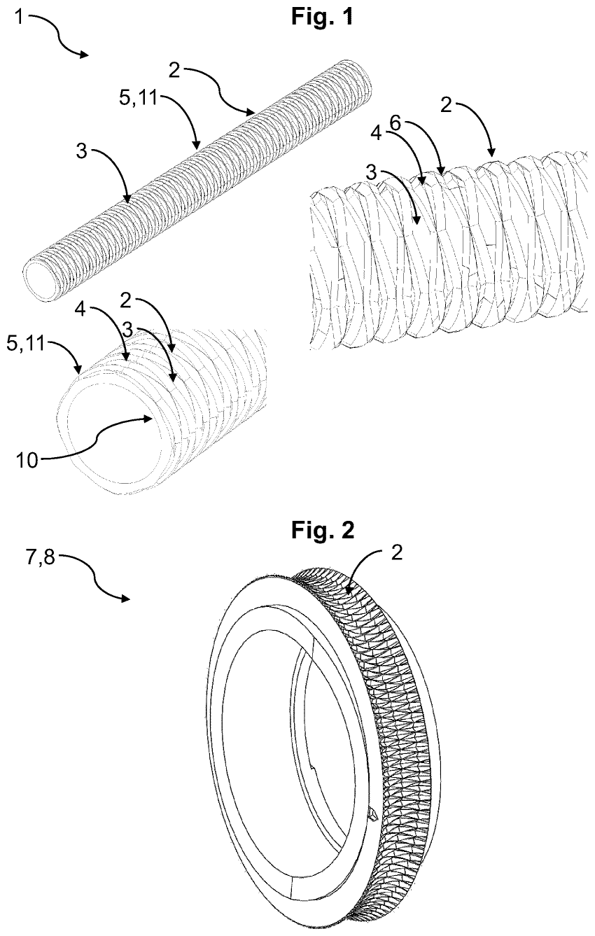

FIG. 1 shows a hose assembly, denoted overall by 1, in particular for conducting fluids, having an external embossed structure 2, which is periodic in a running direction of the hose assembly 1 and has different layer thicknesses 1. The structure 2 has circumferential ribs 3, the axial extent of which varies periodically along a circumference. Furthermore, it is shown that two adjacent ribs 3 are identical. The gaps formed by a reduction in the axial extent are filled by locally limited, matching elevations 4.

The elevations 4 and the ribs 3 are biconvex in this exemplary embodiment.

Furthermore, it is shown in this exemplary embodiment that the structure 2 is formed on an outer layer 5 or second layer 11 of the hose assembly 1, while a first layer 10 defines an inner diameter of the hose assembly 1. The two layers 10, 11 are connected in an integrally bonded manner.

It can thus be stated that the hose assembly 1 in this exemplary embodiment is formed in a plurality of layers, with the elevations 4 being smaller than the ribs 3.

Crossing and intersecting linear depressions 6 are formed between two adjacent ribs 3 or in a transition between a rib 3 and an elevation 4. It is also shown that the elevations 4 filling the gaps are offset with respect to the ribs 3 in axial extent.

FIG. 2 shows an embossing die 7, which is formed therein and in the following exemplary embodiments as an embossing roller 8. Components and functional units which are similar or identical functionally and/or structurally to the preceding exemplary embodiment are denoted by the same reference signs and not described once again separately.

The embossing roller 8 bears the opposite or negative structure 2 corresponding to the applied structure 2.

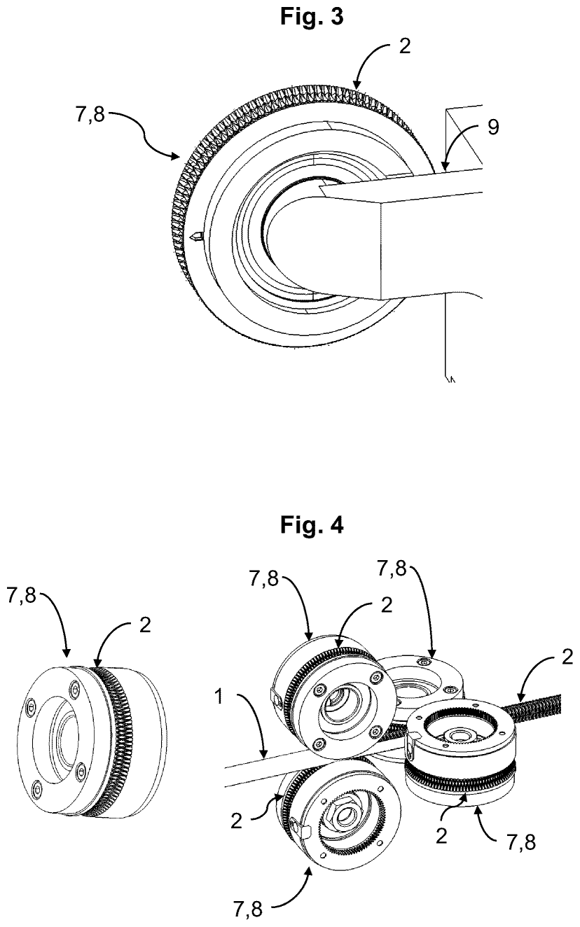

FIG. 3 shows a further embossing roller 8, which is rotatably mounted or positioned in a positionable holding device 9.

FIG. 4 shows another exemplary embodiment of a further embossing roller 8 and a total of four embossing rollers 8, which are rollable on the hose assembly 1, during introduction of the structure 2 on the hose assembly 1.

In this case, two embossing dies 7 and embossing rollers 8 are arranged opposite each other and thus form an abutment during the embossing. It is also shown that in each case two pairs of embossing rollers are axially offset along the hose assembly 1 and arranged at a right angle to one another.

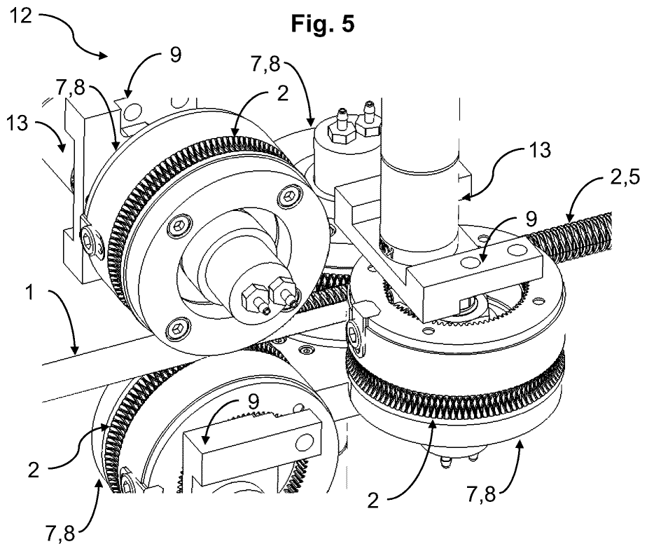

FIG. 5 shows a device, denoted in its entirely by 12, for introducing the structure on the hose assembly 1, wherein the embossing rollers 8 in this exemplary embodiment are arranged according to the exemplary embodiment according to FIG. 4.

In contrast to FIG. 4, it is additionally shown that the embossing rollers 8 are rotatably mounted by holding devices 9 which are in each case already fed in and positioned holding devices 9, and are driven by a drive unit 13. For this purpose, the embossing rollers 8 for introducing the structure 2 are moved together either automatically or manually.

The embossing rollers 8 are also cooled by a cooling unit (not shown specifically) during the introduction of the structure 2 in order to prevent adhesion of the outer layer 5, which is plasticized above a glass transition temperature, of the hose assembly 1.

In an exemplary embodiment which is not shown, synchronized rolling of the embossing dies 7 on the hose assembly 1 is generated by an electronic control system.

In an exemplary embodiment which is not shown, the device 12 with the embossing dies 7 is arranged in a stationary or adaptable manner downstream of an extruder and is thus part of an extrusion process.

According to the invention, a hose assembly 1 having a structure 2 is therefore proposed, wherein the structure 2 has circumferential ribs 3, the axial extent of which varies, preferably periodically, along a circumference, and locally limited gap-filling elevations 4, as a result of which, in turn, a braiding impression is produced, without a separate braiding of the hose assembly 1 being carried out, and wherein the structure 2 is applied by at least two embossing dies 7, in particular embossing rollers 8, which are rollable on the hose assembly 1, in particular are rollable in synchronism on the hose assembly, and are part of an extrusion process.

### LIST OF REFERENCE SIGNS

1 Hose assembly
2 Structure
3 Ribs
4 Elevation
5 Outer layer
6 Depressions
7 Embossing die
8 Embossing roller
9 Holding device
10 First layer
11 Second layer
12 Device
13 Drive unit

1. A hose assembly (1), comprising:
an external structure (2) that is embossed.

2. The hose assembly (1) as claimed in claim 1, wherein the structure (2) is at least one of a) periodic in a running direction of the hose assembly (1), b) has different layer thicknesses, or c) is an outer layer (5).

3. The hose assembly (1) as claimed in claim 1, wherein the structure (2) is formed in an outer layer (5) applied to an inner layer, and the outer layer and the inner layer are connected to each other by integral bonding.

4. The hose assembly (1) as claimed in claim 3, wherein the outer layer (5) is comprised of at least one of a thermoplastic or an elastomer plastic.

5. The hose assembly (1) as claimed in claim 1, further comprising an inner hose wall having a thickness and an outer hose wall having a thickness, and a ratio of the outer hose wall thickness to the inner hose wall thickness is greater than 0.1 and less than 5.

6. The hose assembly (1) as claimed in claim 1, wherein the external structure comprises a thermoplastic, and the embossed thermoplastic has a modulus of elasticity (e modulus) of at least 1000 MPa.

7. A hose assembly (1), comprising:
an external structure (2) with at least one circumferential rib (3), wherein the at least one circumferential rib (3) has an axial extent, which varies along a circumference, and at least one of a) at least two of the ribs (3) are identical, or b) gaps formed by a reduction in an axial extent are filled by locally limited elevations (4).

8. The hose assembly (1) as claimed in claim 7, wherein the hose assembly (1) is formed in multiple layers, and at least one of a) the structure (2) is formed on an outer one of the multiple layers (5), or there is an integrally bonded connection between at least two of the multiple layers.

9. The hose assembly (1) as claimed in claim 8, wherein the at least one circumferential rib comprises a plurality of ribs, and at least one of crossing or intersecting depressions (6) are formed at at least one point between adjacent ones of the ribs (3).

10. The hose assembly (1) as claimed in claim 7, wherein at least one of the ribs (3) or the elevations (4) are biconvex.

11. The hose assembly (1) as claimed in claim 7, wherein the elevations (4) filling the gaps differ in size from the ribs (3).

12. The hose assembly (1) as claimed in claim 1, wherein the structure (2) includes circumferential ribs (3), an axial extent of which varies along a circumference, and gaps formed by a reduction in the axial extent are filled by locally limited elevations (4) which are offset in axial extent with respect to the ribs (3), wherein depressions (6) are formed in a transition between one of the ribs (3) and one of the elevations (4), and at least two of the depressions (6) cross one another.

13. A device (12) for introducing a structure (2) on a hose assembly (1), the device (12) comprising:
at least two embossing dies (7), located downstream of an extruder, and the at least two embossing dies (7) are rollable on a hose assembly (1).

14. The device (12) as claimed in claim 13, wherein the at least two embossing dies (7) are formed opposite one another, such that they form an abutment during introduction of the structure (2) onto the hose assembly (1).

15. The device (12) as claimed in claim 13, further comprising a drive unit (13) that drives the at least two embossing dies (7).

16. The device (12) as claimed in claim 13, wherein the at least two embossing dies (7) are rotatably mounted by a respective holding device (9) that is at least one of positionable or adjustable.

17. The device (12) as claimed in claim 13, wherein at least two of the at least two embossing dies (7) are located opposite one another and are at least one of on an identical plane or axially offset to one another with respect to at least two other ones of the at least two opposite embossing dies (7).

18. A method for introducing a structure (2) on an extruded hose assembly (1), the method comprising:
applying a second layer (11) to a first extruded layer (10) in an integrally bonded manner; and
applying a circumferential structure (2) to the second layer (11) via at least two embossing dies (7) which are rollable on the hose assembly (1).

19. The method as claimed in claim 18, further comprising rolling the at least two embossing dies (7) synchronously to one another on the hose assembly (1).

20. The method as claimed in claim 18, further comprising moving the embossing dies (7) together and then moving the embossing dies (7) apart in order to introduce the structure (2).

21. The method as claimed in claim 18, further comprising cooling the embossing dies (7) at least one of before or during the introduction of the structure (2).
